(19) United States
(12) Patent Application Publication
(10) Pub. No.: US 2009/0282025 A1
(43) Pub. Date: Nov. 12, 2009

(54) METHOD FOR GENERATING A REPRESENTATION OF IMAGE CONTENT USING IMAGE SEARCH AND RETRIEVAL CRITERIA

(75) Inventors: Alexandre Winter, Washington, DC (US); Chahab Nastar, Paris (FR); Sebastien Gilles, Paris (FR); Frederic Jahard, Vincennes (FR)

Correspondence Address: MICHAUD-DUFFY GROUP LLP, 306 INDUSTRIAL PARK ROAD, SUITE 206, MIDDLETOWN, CT, 06457, US

(73) Assignee: LTU TECHNOLOGIES S.A.S., Paris (FR)

(21) Appl. No.: 12/432,119

(22) Filed: Apr. 29, 2009

Related U.S. Application Data
(60) Provisional application No. 61/048,695, filed on Apr. 29, 2008.

(51) Int. Cl. G06F 17/30; G06K 9/46; G06K 9/00

(52) U.S. Cl. 707/5; 382/190; 382/165; 707/E17.03

(57) ABSTRACT

A method for generating representations of visual characteristics of images is presented. The method includes receiving search criteria. The criteria include images to be searched, query images and expected result sets, and a retrieval metric. The method identifies objects within each image and selectively generates a representation of visual characteristics of each image using descriptors from an inventory of descriptors in accordance with the retrieval metric. The method compares the representations of the query image to representations of the images to be searched and determines a search result. The search result is compared to the expected result. If the results do not match, the generating, comparing and determining steps are re-executed with reselected descriptors based on the search result and the retrieval metric. The re-execution continues in a trial-and-error approach until acceptable search results are achieved. When achieved, the method encodes the process for generating the representations.

### CROSS-REFERENCE TO RELATED APPLICATIONS

This patent application claims priority benefit under 35 U.S.C. § 119(e) of copending, U.S. Provisional Patent Application, Ser. No. 61/048,695, filed Apr. 29, 2008, the disclosure of this U.S. patent application is incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND OF THE INVENTION

1. Field of the Invention

This invention relates generally to image analysis systems and methods and, more particularly, to the generation of representations of image content (referred to herein as content DNA) using image search and retrieval criteria.

2. Description of Related Art

There has been an exponential growth in the availability of visual information within the information processing field. This growth is due in part to the widespread use of digital scanners, cameras, and video equipment for capturing, inputting and storing image data, as well as the availability of communication networks such as, for example, the Internet, that permit a wide distribution of visual information. Moreover, the growth in the use and distribution of visual information is seen not only in the public and private sectors but also within governmental and law enforcement institutions. For example, individuals often share visual information such as digital photographs between and among family and friends by electronic mail message or by providing access to a data repository storing the visual information. Corporations, public and private libraries and museums often gather and collect visual information documenting copyrighted intellectual property, elements within the collections, and the like. These repositories are also made available to the public in general or by password access to a subset of the public authorized to review the visual information. Governmental and law enforcement institutions typically store mug shots, finger prints, and other visual information to assist investigation activities and/or periodically search for visual information of interest to enforcement of certain laws (e.g., identify offensive pornographic images of minors) or to security concerns in general. As can be appreciated, data repositories (e.g., image databases) for storing this visual information can be relatively large making such searches cumbersome.

With the ever increasing availability of visual information, techniques are needed that can efficiently and effectively search, locate and retrieve visual information from large data repositories that meet criteria of interest to a person. Conventional search techniques typically include, for example, associating a textual description of the content of the visual information and storing the description in an index. The index is searched using, for example, “key word” queries, to identify visual information that includes the query term(s). Once the index entry is found, a link provides access to the actual visual information associated to the index entry. Generally speaking, this type of indexing and searching technique requires that textual descriptions be entered on an image-by-image basis. As can be appreciated, this technique has deficiencies particularly for large data repositories. For example, it is difficult to establish and maintain accurate descriptions of the image data within the various image repositories. Not only is image data constantly changing (e.g., added, modified and deleted) within the repository, but even when constantly updated to reflect changes to the visual information, the description may be inaccurate as important features of the image data may be missed or not adequately described. In yet another conventional search process, text that surrounds an image within a document is analyzed by similar key word queries. As with the aforementioned index technique, such a search process can be highly inaccurate.

Other techniques for searching visual information in image data repositories include comparing the visual information stored in the repository to a query image. One such technique, typically referred to as a Query-By-Pictorial-Example (QBPE) approach, compares one or more features of the query image to features of the visual information stored within an image data repository. Visual information that “matches” the query image is returned to the person initiating the search. As should be appreciated, and as is described in further detail below, identifying “matches” in such search and retrieval systems include identifying images within a predetermined threshold of similarity to the query image.

Like key word-index searching systems, QBPE systems also require a mechanism for cataloguing images in accordance with the content of the visual information on an image-by-image basis. For example, one or more features of each visual image must be identified and catalogued to facilitate search and retrieval. While systems requiring manual entry of features within each image exist, automated approaches for identifying and cataloging features are now in use. In this regard, each of a plurality of digital images is analyzed and features are identified within the image. Descriptors are generated for each identified feature. As is generally known in the art, descriptors qualify visual features of an image such as, for example, its color, texture, shape, spatial configuration, and the like. The descriptors and a link (e.g., pointer) to the image associated with the descriptors are used to create a searchable index entry for each image. The query image is processed in a like manner to identify and catalogue its features and descriptors. During a search, the descriptors for the query image are compared to those in the searchable index and index entries corresponding to matching images are presented as search results.

The inventors have realized that the success of conventional image search and retrieval systems at identifying images of interest to the person initiating the search is largely dependent on the quality (e.g., accuracy) of the index entries. For example, success is dependent on the accuracy of the identified features and the descriptors associated with that feature as well as the manner in which the features and descriptors are combined and utilized during a search and retrieval process. In QBPE systems, the accuracy of both the query image index and the searchable index affect performance. Accordingly, the inventors have realized that a need exists for an improved system and method for retrieving images including, or likely to include, features of a query image. In one embodiment, systems and methods include generation of a unique description of the graphical content of images (e.g., content DNA) in a universe of search images and query images. The inventors have also discovered that search performance is improved by optimizing various aspects of the search. For example, the inventors have discovered that conducting a search knowing the visual information being sought, for example, whether the searcher is seeking images that match a query image as opposed to seeking images that are similar to the query image within a predetermined threshold (e.g., cloned images differing in that objects are translated or rotated in the image plane, scaled up or down, and the like), permits refinement of the search including which descriptors and which underlying features of the query image and search images should be compared. As a result, QBPE type systems employing content DNA within the search index and optimization procedures (as described herein) provide more efficient and effective search results.

### SUMMARY OF THE INVENTION

The present invention is directed to a method for generating representations of visual characteristics of a plurality of images. The method includes receiving image search and retrieval criteria provided by a person initiating a search. The search criteria include a plurality of images to be searched, a plurality of query images and expected result sets, and retrieval metric. Once the criteria is received, the method includes identifying objects within and features of each image in the plurality of images to be searched and the query images, and selectively generating a representation of the visual characteristics of each of the images from the identified objects and features of each image using one or more descriptors selected from an inventory of descriptors in accordance with the retrieval metric. In accordance with the present invention, optimization of the combination of visual characteristics of the image, via selection and treatment of descriptors, is emphasized. In one embodiment, the representations of the visual characteristics are each comprised of a binary vector obtained from a set of the descriptors. The representations are referred to herein as content DNA for the respective images. In one embodiment, the descriptors have an associated weight characteristic such that one or more identified objects and features may be emphasized in the search, as described below.

The method continues by comparing the representation of one of the query images to the representations of the images to be searched and determining a search result including images from the images to be searched that are similar to the query image. In one embodiment, the search result is provided to a display device of the searcher for review and approval. The method continues by determining whether the search result matches (within a predetermined level or range of accuracy) the expected result corresponding to the query image. When the search result and the expected result do not match, the method returns to the selectively generating step to reselect descriptors from the inventory of descriptors based on the search result and the retrieval metric and re-executing the selectively generating, comparing and determining steps. In one embodiment, the selectively generating, comparing and determining steps are repeatedly executed in a trial-and-error approach until acceptable search results are achieved. When the search result and the expected result match, acceptable results are found and the method continues by encoding the process for generating the representations.

In accordance with one aspect of the present invention, the retrieval metric includes an indication as to whether matching images, cloned images, visually similar images, and semantically similar images should be retrieved. In one embodiment, the retrieval metric also includes an indication as to whether images should be retrieved under a recall oriented system or a precision oriented system. In another embodiment, the retrieval metric includes an indication as to how the search result should be presented to the searcher including at least one of presenting images in a decreasing order of similarity and presenting images such that a subset of the search result that match the query image are presented.

In one embodiment, the inventory of descriptors includes descriptors within classifications of color, texture, shape, and composites thereof. In accordance with the present invention, the descriptors are designed to be robust to changes in image quality, noise, image size, image brightness, contrast, distortion, object translation and transformation, object rotation and scale.

In yet another embodiment, one or more of the descriptors within the inventory of descriptors include a weight characteristic. The weight characteristic permits emphasizing one or more descriptors when determining a similarity of an image to the query image. In one embodiment, the weight value is a relative value such that the sum of the weights employed equal one. For example, whether there are five, six or more descriptors employed within a given analysis, the sum of the weights for each descriptor total one. In one embodiment, when re-executing the selectively generating step, the weight characteristic for the reselected descriptor is adjusted (e.g., increased or decreased in value).

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 illustrates an image recognition and retrieval system, in accordance with one embodiment of the present invention, for identifying visual information of interest to a person initiating a search;

FIG. 2 depicts a process flow illustrating, in accordance to one embodiment of the present invention, steps for analyzing images to provide a representation of the graphical content of the image;

FIG. 3 graphically illustrates image understanding and a relationship between metrics for analyzing images, in accordance with one embodiment of the present invention; and

FIG. 4 depicts a process flow illustrating, in accordance with one embodiment of the present invention, steps for generating representations of graphical content of images based on search and retrieval criteria.

In these figures like structures are assigned like reference numerals, but may not be referenced in the description of all figures.

### DETAILED DESCRIPTION OF THE PREFERRED EMBODIMENTS

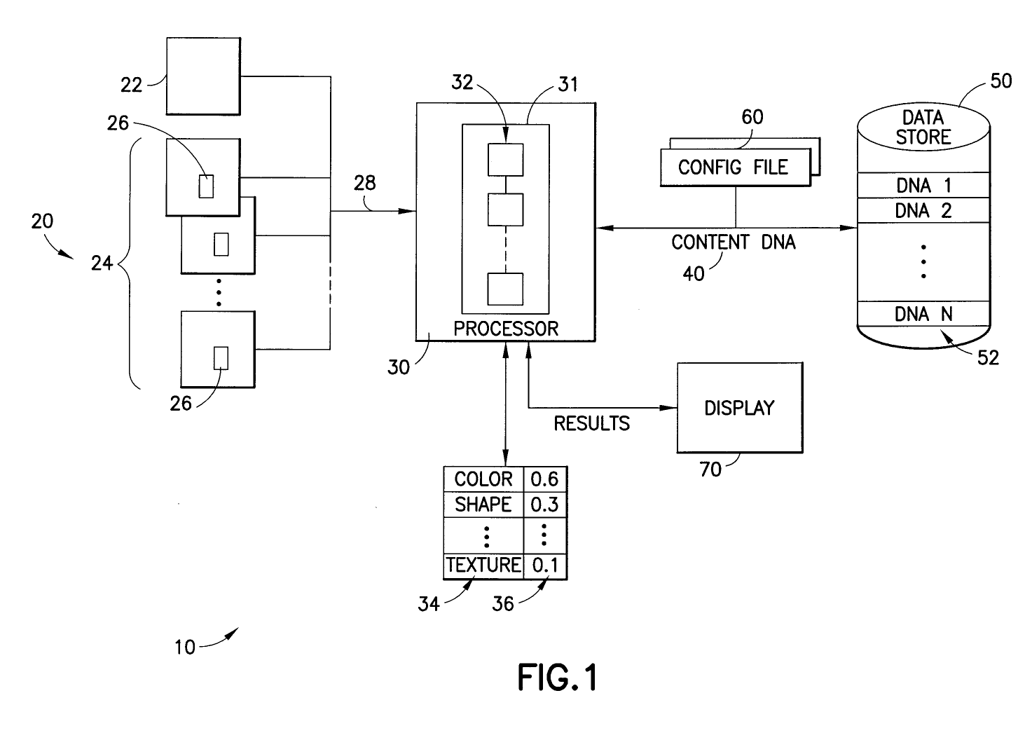

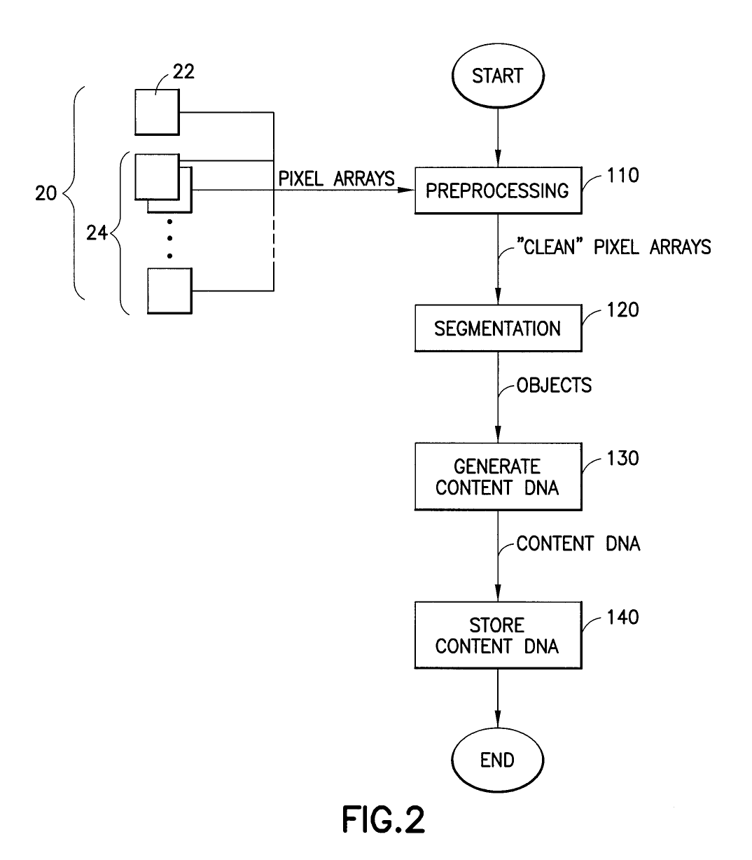

As illustrated in FIGS. 1 and 2, the present invention provides an image recognition and retrieval system 10 implemented to identify visual information of interest to a person initiating a search. In one embodiment, the visual information is contained in image data, shown generally at 20, including, for example, digital photographs, web crawled images, scanned documents, video images, and electronic information including the foregoing. In accordance with the present invention, the image recognition and retrieval system 10 includes a processor 30 exercising a plurality of algorithms (described below) for generating a description of graphical content of images, referred to herein as content DNA 40, for each image within a universe of images to be searched. As described herein, the image recognition and retrieval system 10 employing content DNA within search indexes provides more efficient and effective search results than is achieved in conventional image search systems.

It should be appreciated that the processor 30 includes a computer-readable medium or memory 31 having algorithms stored therein, and input-output devices for facilitating communication over a network 28 such as, for example, the Internet, an intranet, an extranet, or like distributed communication platform connecting computing devices over wired and/or wireless connections, to receive and process the image data 20. In one embodiment, the processor 30 is comprised of, for example, a standalone or networked personal computer (PC), workstation, laptop, tablet computer, personal digital assistant, pocket PC, Internet-enabled mobile radiotelephone, pager or like portable computing devices having appropriate processing power for image processing.

As shown in FIG. 1, the processor 30 includes a distributable set of algorithms 32 executing application steps to perform image recognition tasks. Initially, a plurality of images (e.g., the image data 20) is identified for processing. The images 20 include a universe of images or image set 24 for evaluation as well as a query or reference image 22 inputted, or otherwise identified, by the person initiating the search. As described below, the image set 24 includes images, or parts thereof, having or likely to have visual information of interest 26 to the person initiating a search of the image set 24. As is known in the art, each image in the plurality of images 20 is represented as an array of pixels. Referring to FIGS. 1 and 2, at Block 110, each image (pixel array) in the plurality of images 20 is preprocessed and normalized. The preprocessing step includes executing a set of conventional image processing routines (e.g. one or more of the algorithms 32) that include, for example, geometric image transforms, image equalization and normalization, color space transforms, image quantization, image de-noising, standard image filtering, multi-scale transformations, mathematical morphology tools and the like. Once preprocessed, each pixel array is passed to Block 120 as “clean” pixels. At Block 120, the clean pixels are processed in an image segmentation step. As is generally known, an image includes a representation of various objects. Segmenting techniques analyze components of the image to identify object boundaries. Techniques employed at the segmentation step 120 include, for example, color-based and image-based segmentation such as, for example, spectral analysis, edge detection, histogramming, linear filter operations, high order statistics, and the like, as are generally known in the art. Color-based methods detect clusters in a feature space and image-based methods detect image regions that maximize a homogeneity criterion. Those skilled in the art recognize limitations in conventional segmentation techniques. For example, color-based segmentation techniques tend to overlook the spatial relationships between pixels and image-based segmentation techniques focus on features which may be unrelated to those used for indexing.

In one embodiment of the present invention, one of the algorithms 32 executed in the segmentation step 120 is a Differential Feature Distribution Map algorithm (DFDM) developed by the inventors and described in a presentation entitled “Differential feature distribution maps for image segmentation and region queries in image databases,” given by A. Winter and C. Nastar at the 1999 Content-Based Access of Image and Video Libraries Workshop (CBAIVL99), the subject matter of which is incorporated by reference herein in its entirety. The DFDM algorithm segments an image using a non-parametric approach, relaxing the need for a model of feature distribution. As employed in the image recognition and retrieval system 10 of the present invention, the DFDM algorithm looks for changes in a local feature distribution map and, in particular, those features used for indexing. Because the DFDM algorithm requires no a priori information about the image, the DFDM approach deals successfully with a great variety of images making it ideal for general application. As such, the segmentation step 120 promotes improved image coding by splitting (e.g., segmenting) each image into visually-coherent zones. The output of the segmentation step is objects identified within the image. The objects are passed to Block 130.

At Block 130, the processor 30 generates the content DNA 40 for each image processed. As described in further detail below, the content DNA 40 is comprised of a plurality of visual descriptors and features representing visual properties of the image, for example, visual properties of the identified objects within the image and of the entire image. In accordance with the present invention, in an optimization procedure described below, descriptors included in a particular instance of the content DNA 40 for an image are fine tuned on an application-by-application basis to improve search results. For example, a subset of descriptors and/or pre-computed data (e.g., intermediate data used in distance calculations) may be included in a specific content DNA to improve, for example, computing and/or memory performance, simplify system requirements, and improve robustness. As illustrated in FIGS. 1 and 2, an output of Block 130 is the content DNA 40 for each of the processed images 20. In one embodiment, at Block 140, the content DNA 40 is added to a data store 50. In accordance with one embodiment of the present invention, the content DNA 40 for each image in the plurality of images 20 (e.g., the input image set 24 and the query image 22) is added to the data store 50 as an entry in a searchable index 52.

Now that the searchable index 52 is established for the plurality of images 20, QBPE type searching may be performed or, more appropriately, an improved image recognition and retrieval search technique is available. In accordance with one aspect of the present invention, comparing the content of images 20 using the content DNA 40 permits comparison of semantic characteristics of images to identify not only images that match the query image (e.g., duplicate images) but also images that are clones (e.g., include relatively minor geometrical and photometrical modifications including translated or rotated in the image plane, scaled up or down, and the like), as well as visually similar images (e.g., at a semantic level) within a predetermined threshold.

The inventors have realized that the retrieval of visual similar images is a subjective, application and query dependent analysis. To address this fact, the content DNA 40 is designed, in accordance with the present invention, to be tolerant and adaptive, permitting customization and optimization to aspects of a search that heretofore have not been addressed by conventional search and retrieval systems.

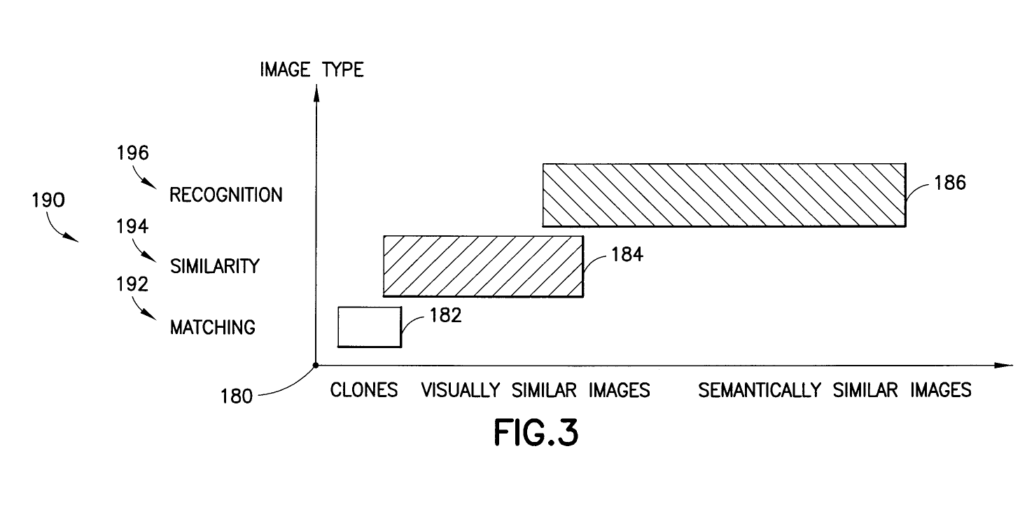

However, before presenting the inventive customization and optimization procedures of the present invention, it should be appreciated that an aim of the present invention is to provide a system that promotes high-level image understanding. Image understanding seeks to infer high level information about an image such as, for example, knowledge of one or more image class labels (e.g., such as in recognition or annotation), or knowledge of a K nearest neighbor of the subject image in a semantic cluster (e.g., such as in image retrieval). Image understanding is illustrated graphically in FIG. 3, where a hypothetic query image is placed at an origin of the illustrated frame, shown generally at 180, and a gradation of similarity types is depicted for three image metrics, shown generally at 190, that are sought in different applications, namely, Matching 192, Similarity 194 and Recognition 196. As shown in FIG. 3, the most constrained image similarity is directed to clones 182 where typically only matching images are retrieved using clone-dedicated metrics described below. A less constraint image similarity is directed to visually similar images 184 in semantic clusters where a retrieval-specific metric is used. The inventors have found that when no assumption can be made on a given image, a system is in an applicative context with the largest scope of images. In that case, the clone-dedicated and retrieval-specific metrics are not efficient due to the large scope. Thus, a recognition-dedicated metrics in which class labels are manipulated is employed for detecting semantically similar images 186.

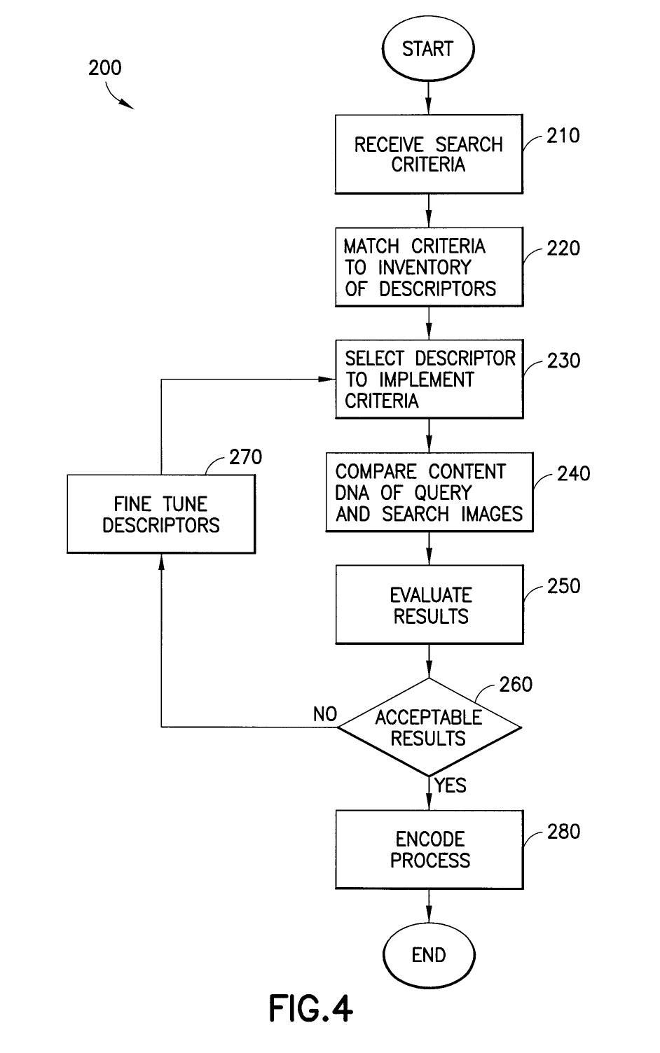

As follows from the above described effort to achieve high-level image understanding, information concerning the person initiating the search and the images searched, for example, expected search results, whether shapes, colors, or a sub-part of the query image is more important to a particular search and the like, influence how the search is performed. In accordance with one aspect of the present invention, such information is utilized in the process of developing the content DNA for each image in the plurality of images 24 defining the universe of images to be searched. The inventors have discovered that incorporating such information into the content DNA 40 and thus entries of the search index 52, greatly improves the accuracy and efficiency of search tasks. FIG. 4 illustrates a process 200 for developing content DNA 40 in accordance with one embodiment of the present invention.

With reference to FIGS. 1 and 4, the process 200 begins at Block 210 where criteria for a desired search are defined. At Block 210, the searcher (e.g., the person initiating the search) provides images comprising the universe of images to be search (e.g., the image set 24). The image set 24 is defined as large as possible. Additionally, the searcher provides a plurality of query images (e.g., the query image 22) and expected result sets. The query images include the visual information of interest 26 to be identified within the image set 24. In one embodiment, the visual information of interest includes the entire contents of the query image or a portion of the query image. In one embodiment, the result set includes images within what the searcher believes should be the result obtained from the search. For example, the searcher provides images that include the visual information of interest 26 to the searcher. Results sets include, for example, images retrieved using a recall oriented system and/or a precision oriented system. In a recall oriented system, images around matching images including, for example, irrelevant images, may be retrieved. In a precision oriented system, images within a first rank of similarity are retrieved. Thus, a precision oriented search is designed to only retrieve relevant images. The searcher also determines whether the search should be executed as a retrieval oriented search or as a matching oriented search. As is generally known, a retrieval search presents search results in a decreasing order of similarity while a matching system selects a subset of the results that match the search query. In accordance with the present invention, retrieval metric identifies the requested search as at least one of a recall oriented, precision oriented, retrieval oriented and a matching oriented search.

Once the searcher's requirements and criteria are defined, the process 200 proceeds to Block 220, where the criteria is matched to an inventory of available descriptors 34 such that the content DNA 40 for each image (or segmented objects within the image) is generated to best implement the search requirements and criteria specified by the searcher. For example, and as described above, the content DNA encodes relevant graphical features of each image (e.g., each image in the image set 24 and the query image 22). In one embodiment, the content DNA is a binary vector obtained from a set of image descriptors (e.g., visual descriptors) derived from the images. The image descriptors (e.g., those chosen for the inventory of available descriptors 34) encode visual features of objects within each image including, for example, descriptors 34 within the following classifications of descriptors: color, texture, shape, correlation of features and composites of the above, for each of the images. In accordance with the present invention, the image descriptors encode visual features of objects within the image such as, for example, features within the aforementioned color, texture and shape classifications. The descriptors are designed to be robust to changes in image quality, noise, size, brightness, contrast, distortion, object translation and transformation, object rotation and scale, such that the content DNA improves the ability to locate related/matching images. In one embodiment, object transformations include, for example, geometric transformations such as cropping, border adding, rotation, resizing and the like, photometric transformations such as equalizations, contrast, luminance, noise, JPEG encoding and the like, and minor content transformations such as captioning and the like. It should be appreciated that the descriptors include those derived from proprietary algorithms such as for example, GLI and publicly available algorithms RGB space, LAB, LUV or HSV space color histogram, Image Shape Spectrum (ISS) and Image Curvature Spectrum (ICS), Fourier Transforms (FFT), wavelet bands energy level (WAV), Canny-Deriche edge orientation histograms, and the like.

As can be appreciated, when attempting to retrieve a certain class of images, some descriptors may be more relevant than others. For example, if the universe of images includes only black and white images or images having the same color tone, there is no need to evaluate different colors and similarity within a color spectrum. In one embodiment, the inventory of descriptors 34 includes about fifty (50) descriptors within the aforementioned classifications of color, texture, shape, and composites of the foregoing, such as, for example, color and/or contour dependencies, shape derivatives, and the like. In accordance with the present invention, one or more of the descriptors within the inventory of descriptors 34 include a weight characteristic 36 such that one or more descriptors 34 may be emphasized, or given higher importance and significance, than other descriptors 34 in determining the similarity of an image to the query image or portion thereof.

Once a “starting point” has been determined, for example, a first set of descriptors and/or weight values are chosen from the inventory of descriptors, a trial and error scheme is invoked including Blocks 230 to 270. At Block 230, the chosen descriptors 34 and weights 36 are used to generate content DNA 40 for the images within the plurality of images 24 defining the universe of images to be searched. At Block 240, the search index 52 including the generated content DNA 40 is evaluated. That is, the content DNA 40 for the query image 22 is compared to the content DNA 40 for each image in the image set 24. As can be appreciated, images are retrieved based on the specified retrieval metric (e.g., whether matching images, cloned images, visually similar images, and/or semantically similar images should be retrieved) and a distance measured between vectors comprising the content DNA 40 for the query image 22 and the content DNA 40 for each of the images within the plurality of images 24. As should also be appreciated, conventional and proprietary comparison algorithms may be employed to identify “matching” images within a predetermined matching range of accuracy values or threshold value of accuracy. For example, “matches” are identified by applying a distance function to the content DNA for the query image 22 and the content DNA 40 for each of the images within the plurality of images 24, and computing a distance threshold such that a lower distance threshold represents images that are close (e.g., more similar) to each other. Conventional comparison algorithms include, for example, standard L1, Hellinger, Bhattacharya, L2, intersection, and like data comparison algorithms.

At Block 250 the images meeting the specified retrieval metric are provided to the searcher for analysis. In one embodiment, the retrieved images are presented to the searcher on a display device 70 of a processing unit operated by the searcher, as are generally known in the art. The searcher reviews the retrieved images to ensure that the searcher's requirements and criteria for the search have been met. That is, whether or not the searcher is satisfied that the visual information of interest 26 has been detected within the retrieved images. At Block 260, a determination is made by the searcher whether the initiated search was successful. For example, the searcher determines whether the retrieved images meet the requirements specified at the beginning of the search. If the retrieved images do not match the searcher's requirements, the process 200 passes to Block 270 along a “No” path. At Block 270, the inventory of descriptors 34 is again presented to the searcher. The searcher may then fine-tune specific descriptors 34 and/or weights 36 to define a next set of descriptors 34 and weights 36 to be used in generating content DNA 40 for the image set 24 and query image 22. The process continues at Block 230 where the next set of descriptors 34 and weights 36 are used to generate content DNA 40 for the images within the plurality of images 24 defining the universe of images to be searched. At Block 240 the search index 50 including the content DNA 40 generated from the next set of descriptors and weights is evaluated. At Block 260, images are retrieved based on the specified retrieval metric and the next set of descriptors 34 and weights 36, which now give greater significance to one or more other features of the query image 22 and image set 24 such that a different subset of images are retrieved from the image set 24. At Block 250, the subsequent search results are evaluated. If, at Block 260, a successful search is still not been achieved, control again passes to Block 270 where the descriptors 34 and weights 36 are again fine-tuned and the trail and error process of Block 230 to 270 continues. Once a successful search is conducted and the retrieved images match the searcher's expectations, control passes from Block 260 to Block 280 along a “Yes” path.

It should be appreciated that a “successful” search is defined not only by the accuracy of the images retrieved but also by performance measurements. For example, a successful search is one that is performed within an acceptable range of computational time and which consumes an acceptable amount of computing resources (e.g., memory and/or percentage of processor utilization).

It should also be appreciated that the aforementioned trial and error process (e.g., steps 230 to 270) may be performed, in one embodiment, as a manual process with the searcher and/or an administrator of the process 200 reviewing each search result and fine tuning descriptors 34 and weights 36 as needed. In another embodiment, the trial and error process may be an automated process such that weights 36 for corresponding ones of the descriptors 34 are incrementally adjusted (e.g., increased or decreased in value) and evaluated to determine relative effectiveness for retrieving the visual information of interest 26 within the image set 24. In one embodiment, weight values 36 may range from zero to one, where a weight value of zero, in effect, eliminates the descriptor 34 from affecting a particular search.

As noted above, once an acceptable search is performed, the process 200 passes from Block 260 to Block 280. At Block 280, the process for determining the content DNA is encoded for subsequent searches. In one embodiment, the encoding step includes, for example, creating one or more configuration files (e.g., a config file 60) that defines the settings for the content DNA building process 200 such as defining the set of descriptors 34, their weights 36, the specified retrieval metric (e.g., whether matching images, cloned images, visually similar images, and/or semantically similar images should be retrieved), the combination method (e.g., whether images should be retrieved under a recall oriented system or a precision oriented system), and how the retrieved images should be presented to the searcher (e.g., as search oriented results in a decreasing order of similarity or in a matching oriented results where subset of the results that match the search query are presented). Once the encoding step is complete, the process 200 is concluded.

It should be appreciated that the config file 60 permits the searcher to build content DNA 40 and expand the search index 52 to accommodate additional images as the searcher expands the image set 24. In such an embodiment, one or more of the config file 60 is retained on the searcher's processing device and may be invoked as needed to enhance the search index 52 with new content DNA 40. It should also be appreciated that it is within the scope of the present invention to restart the process 200 for developing content DNA on a regular basis so as to adapt the process 200 to a changing corpus of images, for example, changing images within the image set 24 and query images 22.

As described above, the visual information of interest 26 may include the entire query image 22 or a portion of the query image 22 (e.g., an image sub-part). In one embodiment, in order to explicitly focus the similarity on sub-parts of an image, front-end tools are available to crop a part of any query image 22, and initiate a search for images within the image set 24 that are similar to that part of the query image 22 only. For example, with respect to a car, one might wish to locate similar wheels. As such, the searcher crops a portion of the query image 22 including the wheel and submits that portion as the query image 22 as a search request to the retrieval system 10.

In one embodiment, the “trial and error” process (Blocks 230 to 270 of the process 200) can be leveraged to permit real-time, implicit customization, for example, during the trial and error steps the searcher provides the system 10 several examples of what the searcher is looking for. For instance, the searcher first provides a blue square to the system. Then, a red square or a blue circle will both be identified by the system 10 as similar to an inputted query, and would be presented as a search result by the system 10. The searcher can then implicitly refine the inputted query by selecting the red square and teach the system to retrieve squares. Alternatively, the searcher select a blue circle that is also presented by the system 10 (e.g., similar in color to the input query) to teach the system 10 to retrieve blue objects. In practice, this functionality is used to perform high precision queries, and each “refined search profile” can be stored to be re-used in other search sessions.

In one embodiment, the “trial and error” process permits “off-line” implicit customization. For example, metrics employed in searches are optimized for a specific environment. Specialized applications such as, for example, logo search, industrial parts searches, medical image database searches, and the like, focus on particular images. In order to optimize the search to provide relevant search results, the system 10 can be customized for a specific environment, where either the images searched are particular, or the searcher's expectations are particular. To address this need, an offline metric optimization process accepts a searcher's “ground truth” as an input. The “ground truth” is a set of images that are declared similar by the searcher. Then, the metric parameters (e.g., the descriptors 34 and weights 36) are optimized towards this ground truth using, for example, neural networks, Bayesian networks and other optimization methods.

In yet another embodiment, the retrieval system 10 combines keyword searching techniques and visual searching techniques to provide a powerful image search application. For example, the system 10 includes an integrated keyword and visual searching algorithm. The combination algorithm uses semantic information contained in the inputted keywords and visual information contained in the image DNA 40 when evaluating images within the image set 24. The inventors have found that the combination algorithm, e.g., employing image and keyword searching techniques, improves upon the perceived weaknesses of searching by only one approach and increases the resulting search power.

Although described in the context of preferred embodiments, it should be realized that a number of modifications to these teachings may occur to one skilled in the art. Accordingly, it will be understood by those skilled in the art that changes in form and details may be made therein without departing from the scope and spirit of the invention.

What is claimed is:

1. A method for generating representations of visual characteristics of a plurality of images, the method comprising:
receiving by a processing device an input search criteria provided by a searcher including a plurality of images to be searched, a plurality of query images and expected result sets, and a retrieval metric;
identifying objects within and features of each image in the plurality of images to be searched and the query images;
selectively generating by the processing device executing a set of algorithms a representation of the visual characteristics of each of the images from the identified objects and features of each image using one or more descriptors selected from an inventory of descriptors in accordance with the retrieval metric;
comparing by the processing device the representation of one of the query images to the representations of the images to be searched and determining a search result including images from the images to be searched that are similar to the query image; and
determining whether the search result matches the expected result corresponding to the query image;
wherein when the search result and the expected result do not match, returning to the selectively generating step to reselect descriptors from the inventory of descriptors based on the search result and the retrieval metric and re-executing the selectively generating, comparing and determining steps;
wherein when the search result and the expected result match within at least one of a predetermined range of accuracy values and a threshold value of accuracy, encoding the process for generating the representations.

2. The method for generating of claim 1, wherein the retrieval metric includes an indication as to whether matching images, cloned images, visually similar images, and semantically similar images should be retrieved.

3. The method for generating of claim 1, wherein the retrieval metric includes an indication as to whether images should be retrieved under a recall oriented system or a precision oriented system.

4. The method for generating of claim 1, wherein the retrieval metric includes an indication as to how the search result should be presented to the searcher including at least one of presenting images in a decreasing order of similarity and presenting images such that a subset of the search result that match the query image are presented.

5. The method for generating of claim 1, wherein the step of identifying includes:
preprocessing and normalizing pixel arrays representing each of the plurality of images to provide clean pixel arrays for each image; and
segmenting the clean pixel arrays to analyze components of the images and identify object boundaries therein.

6. The method for generating of claim 5, wherein the segmenting step is comprised of executing a DFDM algorithm to segment each of the images into visually-coherent zones.

7. The method for generating of claim 1, wherein each of the representations is comprised of a binary vector obtained from a set of the descriptors.

8. The method of generating of claim 1, wherein the inventory of descriptors includes descriptors within classifications of at least one of color, texture, shape, correlations of features and composites thereof.

9. The method of generating of claim 8, wherein the descriptors are designed to be robust to changes in image quality, image noise, image size, image brightness and contrast, distortion, object translation and transformation, object rotation, and scale.

10. The method of generating of claim 9, wherein the object transformations include at least one of geometric transformations, photometric transformations, and minor content transformations.

11. The method of generating of claim 10, wherein the geometric transformations include cropping, border adding, rotation, and resizing.

12. The method of generating of claim 10, wherein the photometric transformations include equalizations, contrast, luminance, noise, and JPEG encoding.

13. The method of generating of claim 10, wherein the content transformations include captioning.

14. The method of generating of claim 1, wherein one or more of the descriptors within the inventory of descriptors include a weight characteristic for emphasizing the one or more descriptors when determining a similarity of an image to the query image.

15. The method for generating of claim 14, wherein when re-executing the selectively generating step the weight characteristic for a reselected descriptor is adjusted.

16. The method for generating of claim 1, wherein the encoding the process for generating the representations step is comprised of creating a configuration file that defines the set of descriptors, descriptor weights and the retrieval metric.
